(19) United States
(12) Patent Application Publication
(10) Pub. No.: US 2020/0192110 A1
(43) Pub. Date: Jun. 18, 2020

(54) DISPLAY DEVICE

(71) Applicant: Quantum Optoelectronics Inc., Taipei City (TW)

(72) Inventors: SHIH-PING WU, Taipei City (TW); YU-SHENG LIU, Taipei City (TW); CHI-WEI CHEN, Taipei City (TW); MING-HSIEN TSAI, Taipei City (TW)

(21) Appl. No.: 16/367,966

(22) Filed: Mar. 28, 2019

(30) Foreign Application Priority Data
Dec. 12, 2018 (TW) 107144823

(51) Int. Cl. G02B 27/28; G02B 5/30

(52) U.S. Cl. CPC G02B 27/283; G02B 27/286; G02B 5/3025; G02B 5/3016

(57) ABSTRACT

A display device includes an imaging element, a flat surface light source and a polarization beam splitter. The flat surface light source is used for providing plural illumination beams. A normal line of the flat surface light source and a normal line of the imaging element are not perpendicular to each other. The polarization beam splitter is arranged between the flat surface light source and the imaging element, and has a geometric surface. When the illumination beams from the flat surface light source are projected on the geometric surface, the illumination beams are reflected to the imaging element. The imaging beams from the imaging element are transmitted through the geometric surface. Consequently, an image is outputted. An imaging surface of the imaging surface can be irradiated uniformly by the illumination beams on within a specified viewing angle.

### FIELD OF THE INVENTION

The present invention relates to the field of an optical technology, and more particularly to a display device.

### BACKGROUND OF THE INVENTION

With the advent of the multimedia and Internet eras, the exchange of images and information has become increasingly rapid and various new display technologies have been emerged. With the development of these display technologies, a variety of display technologies have been continuously proposed to solve the problems about various display applications.

Nowadays, the technology of reflective liquid crystal displays becomes one of the development mainstreams of the display technology because the reflective liquid crystal displays have some advantages such as low power consumption and visibility under sunlight. The illumination system for providing light beams to the reflective liquid crystal display is very important for the imaging quality of the reflective liquid crystal display. For example, some techniques about the illumination system of the reflective liquid crystal display are disclosed in U.S. Pat. Nos. 6,433,935, 6,976,759 and 7,529,029.

FIG. 1 schematically illustrates an illumination system disclosed in U.S. Pat. No. 6,433,935. After a light beam from a light source 11 is introduced into a wedge-shaped prism 12, the light beam undergoes a total internal reflection within the wedge-shaped prism 12. Consequently, the projection area and the viewing angle of a reflective liquid crystal display are expanded. The associated technique is disclosed in the patent specification, and detailed descriptions thereof are omitted. However, this illumination system still has some drawbacks. For example, chromatic aberration is formed on an image exit surface 14, the optical axis is skewed and the image is distorted. These problems are detrimental to the subsequent imaging applications.

FIG. 2 schematically illustrates a polarization beam splitter (PBS) assembly disclosed in U.S. Pat. No. 6,976,759. After an illumination beam from a light source is introduced into a prism surface 20, the illumination beam 21 is projected on the prism surface 22 and undergoes a total internal reflection. Consequently, the illumination beam 21 is reflected to a polarization splitting surface 23. When the illumination beam 21 is projected on the polarization splitting surface 23, the illumination beam 21 is reflected to the prism surface 22 by the polarization splitting surface 23. Then, the illumination beam 21 is transmitted through the prism surface 22 and projected on an imaging surface of a reflective light valve 27. When the illumination beam 21 is projected on the imaging surface of the reflective light valve 27, the illumination beam 21 is converted into an imaging beam 26. After the imaging beam 26 is transmitted through the prism surface 22, the polarization splitting surface 23 and a compensation prism 24 sequentially, the imaging beam 26 is outputted. The compensation prism 24 is used for correcting the optical axis. Consequently, the imaging beam 26 is outputted along a normal direction of the reflective light valve 27. However, the arrangement of the compensation prism 24 increases the thickness of the overall PBS assembly. In addition, the distance between the imaging surface of the reflective light valve 27 and a light exit surface 25 is increased. In other words, it is difficult to minimize the PBS assembly and install the PBS assembly in a short-focus optical system.

FIG. 3 schematically illustrates an image display system disclosed in U.S. Pat. No. 7,529,029. A polarization beam splitter 32 of the image display system 30 comprises a curvy surface 34 and a curvy surface 35. By the polarization beam splitter 32, an illumination beam 36 from a light source 31 is guided along an optical path to a reflective light valve 33 and an imaging beam 36′ is guided from the reflective light valve 33. In other words, the image display system integrates an illumination element and an imaging element. However, the combination of the illumination element and the imaging element needs the curvy prism with complicated curvy surfaces. For achieving the desired imaging quality, the curvy prism needs high precision and small tolerance range.

Therefore, the existing display device needs to be further improved.

### SUMMARY OF THE INVENTION

For solving the drawbacks of the conventional technologies, the present invention provides a display device. An imaging surface of an imaging surface can be uniformly irradiated by the illumination beams within a specified viewing angle. Moreover, the process of producing the components of the display device is simplified, and the display device is cost-effective.

In accordance with an aspect of the present invention, a display device is provided. The display device includes an imaging element, a flat surface light source and a polarization beam splitter. The imaging element has an imaging surface for providing an image. The flat surface light source has a light emitting surface for providing plural illumination beams. A normal line of the light emitting surface and a normal line of the imaging surface are not perpendicular to each other. The polarization beam splitter is arranged between the flat surface light source and the imaging element, and has a geometric surface. When at least portions of plural illumination beams in a first polarization state and from the flat surface light source are projected on the geometric surface, the portions of the plural illumination beams in the first polarization state are reflected to the imaging element. After the portions of the plural illumination beams in the first polarization state are projected on the imaging element and exited from the imaging element, the portions of the plural illumination beams in the first polarization state are converted into imaging beams in a second polarization state. Moreover, at least portions of the imaging beams in the second polarization state are transmitted through the geometric surface, so that the image is outputted.

In an embodiment, if a half of a length of a side of the imaging surface is smaller than 2.75 mm, the display device satisfies following mathematic formulae:

−0.047385 Xᵢ²+0.771625 Xᵢ+3.4≤Yᵢ;

Yᵢ≤−0.047385 Xᵢ²+0.771625 Xᵢ+5;

Yᵢ=Mᵢ−Nᵢ; and

69°≤θₜ≤78°,

wherein Xᵢ is a position of the imaging surface and defined according to a coordinate axis, the coordinate axis is parallel with the side of the imaging surface and perpendicular to the normal line of the imaging surface, Mᵢ is a spacing distance between the position of the imaging surface and the geometric surface along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

In an embodiment, the display device further satisfies following mathematic formulae (a1)˜(a6):

if Xᵢ=0, 3.6≤Yᵢ≤3.8; (a1)

if Xᵢ=0, 3.8≤Yᵢ≤4.0; (a2)

if Xᵢ=0, 4.0≤Yᵢ≤4.2; (a3)

if Xᵢ=0, 4.2≤Yᵢ≤4.4; (a4)

if Xᵢ=0, 4.4≤Yᵢ≤4.6; and (a5)

if Xᵢ=0, 4.6≤Yᵢ≤4.8. (a6)

In an embodiment, if a half of a length of a side of the imaging surface is larger than 2.75 mm and smaller than 3.5 mm, the display device satisfies following mathematic formulae:

−0.043299 Xᵢ²+0.745345 Xᵢ+4≤Yᵢ;

Yᵢ≤−0.043299 Xᵢ²+0.745345 Xᵢ+6;

Yᵢ=Mᵢ−Nᵢ; and

68.5°≤θₜ≤82.5°.

wherein Xᵢ is a position of the imaging surface and defined according to a coordinate axis, the coordinate axis is parallel with the side of the imaging surface and perpendicular to the normal line of the imaging surface, Mᵢ is a spacing distance between the position of the imaging surface and the geometric surface along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

In an embodiment, the display device further satisfies following mathematic formulae (b1)˜(b8):

if Xᵢ=0, 4.2≤Yᵢ≤4.4; (b1)

if Xᵢ=0, 4.4≤Yᵢ≤4.6; (b2)

if Xᵢ=0, 4.6≤Yᵢ≤4.8; (b3)

if Xᵢ=0, 4.8≤Yᵢ≤5.0; (b4)

if Xᵢ=0, 5.0≤Yᵢ≤5.2; (b5)

if Xᵢ=0, 5.2≤Yᵢ≤5.4; (b6)

if Xᵢ=0, 5.4≤Yᵢ≤5.6; and (b7)

if Xᵢ=0, 5.6≤Yᵢ≤5.8. (b8)

In an embodiment, the imaging element includes a top glass cover, an intermediate structure and a circuit board. The intermediate structure is arranged between the top glass cover and the circuit board. The imaging surface is disposed within the intermediate structure. A top surface of the imaging element is a top surface of the top glass cover.

In an embodiment, a position of the imaging surface is defined according to a coordinate axis, and the coordinate axis is parallel with the side of the imaging surface and perpendicular to the normal line of the imaging surface. As the position of the imaging surface is moved along an axial direction of the coordinate axis, a spacing distance between the position of the imaging surface and the geometric surface along the normal line of the imaging surface is increased.

In an embodiment, the imaging surface has a rectangular shape, and the side of the imaging surface is a short side of the imaging surface.

In an embodiment, the flat surface light source includes a substrate, plural light emitting diodes and a diffusion plate. The plural light emitting diodes are disposed on the substrate to provide light beams. After the light beams are transmitted through the diffusion plate, a surface light source is generated.

In an embodiment, the flat surface light source includes a light chamber, at least one light emitting diode and a diffusion plate. The at least one light emitting diode is located at a first end of the light chamber. The diffusion plate is located at a second end of the light chamber. Moreover, plural light beams from the light emitting diode are transferred within the light chamber. After the light beams are reflected and scattered by an inner surface of the light chamber, the light beams are projected to the diffusion plate. After the light beams are transmitted through the diffusion plate, a surface light source is generated.

In an embodiment, the flat surface light source includes at least one light emitting diode and a light guide plate. After plural light beams from the at least one light emitting diode are introduced into the light guide plate, the plural light beams are guided by the light guide plate. After the plural light beams are transmitted through the light guide plate, a surface light source is generated.

In an embodiment, the flat surface light source further includes a polarizer. After the plural light beams are transmitted through the polarizer, the plural illumination beams in the first polarization state are generated.

In an embodiment, the imaging element is a LCoS (liquid crystal on silicon) element.

In an embodiment, the polarization beam splitter is a reflective polarizer or a dual brightness enhancement film.

In an embodiment, the polarization beam splitter has a thin film structure.

In accordance with an aspect of the present invention, a display device is provided. The display device includes an imaging element, a flat surface light source and a polarization beam splitter. The imaging element has an imaging surface for providing an image. The flat surface light source provides plural illumination beams. The polarization beam splitter is arranged between the flat surface light source and the imaging element. When at least portions of plural illumination beams in a first polarization state and from the flat surface light source are projected on the polarization beam splitter, the portions of the plural illumination beams in the first polarization state are reflected to the imaging element. Moreover, at least portions of imaging beams in the second polarization state and from the imaging element are transmitted through the polarization beam splitter, so that the image is outputted. A position of the imaging surface is defined according to a coordinate axis. The coordinate axis is parallel with a side of the imaging surface and perpendicular to a normal line of the imaging surface. As the position of the imaging surface is moved along an axial direction of the coordinate axis, a spacing distance between the position of the imaging surface and the geometric surface along the normal line of the imaging surface is increased.

In an embodiment, the flat surface light source has a light emitting surface. Moreover, a normal line of the light emitting surface and the normal line of the imaging surface are not perpendicular to each other.

In an embodiment, if a half of a length of the side of the imaging surface is smaller than 2.75 mm, the display device satisfies following mathematic formulae:

−0.047385 Xᵢ²+0.771625 Xᵢ+3.4≤Yᵢ;

Yᵢ≤−0.047385 Xᵢ²+0.771625 Xᵢ+5;

Yᵢ=Mᵢ−Nᵢ; and

69°≤θₜ≤78°,

wherein Xᵢ is the position of the imaging surface and defined according to the coordinate axis, Mᵢ is the spacing distance between the position of the imaging surface and the polarization beam splitter along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

In an embodiment, the display device further satisfies following mathematic formulae (a1)˜(a6):

if Xᵢ=0, 3.6≤Yᵢ≤3.8; (a1)

if Xᵢ=0, 3.8≤Yᵢ≤4.0; (a2)

if Xᵢ=0, 4.0≤Yᵢ≤4.2; (a3)

if Xᵢ=0, 4.2≤Yᵢ≤4.4; (a4)

if Xᵢ=0, 4.4≤Yᵢ≤4.6; and (a5)

if Xᵢ=0, 4.6≤Yᵢ≤4.8. (a6)

In an embodiment, if a half of a length of the side of the imaging surface is larger than 2.75 mm and smaller than 3.5 mm, the display device satisfies following mathematic formulae:

−0.043299 Xᵢ²+0.745345 Xᵢ+4≤Yᵢ;

Yᵢ≤−0.043299 Xᵢ²+0.745345 Xᵢ+6;

Yᵢ=Mᵢ−Nᵢ; and

68.5°≤θₜ≤82.5°.

wherein Xᵢ is the position of the imaging surface and defined according to the coordinate axis, Mᵢ is the spacing distance between the position of the imaging surface and the polarization beam splitter along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

In an embodiment, the display device further satisfies following mathematic formulae (b1)˜(b8):

if Xᵢ=0, 4.2≤Yᵢ≤4.4; (b1)

if Xᵢ=0, 4.4≤Yᵢ≤4.6; (b2)

if Xᵢ=0, 4.6≤Yᵢ≤4.8; (b3)

if Xᵢ=0, 4.8≤Yᵢ≤5.0; (b4)

if Xᵢ=0, 5.0≤Yᵢ≤5.2; (b5)

if Xᵢ=0, 5.2≤Yᵢ≤5.4; (b6)

if Xᵢ=0, 5.4≤Yᵢ≤5.6; and (b7)

if Xᵢ=0, 5.6≤Yᵢ≤5.8. (b8)

In an embodiment, the imaging element includes a top glass cover, an intermediate structure and a circuit board. The intermediate structure is arranged between the top glass cover and the circuit board. The imaging surface is disposed within the intermediate structure. A top surface of the imaging element is a top surface of the top glass cover.

In an embodiment, the flat surface light source includes a substrate, plural light emitting diodes and a diffusion plate. The plural light emitting diodes are disposed on the substrate to provide light beams. After the light beams are transmitted through the diffusion plate, a surface light source is generated.

In an embodiment, the flat surface light source includes a light chamber, at least one light emitting diode and a diffusion plate. The at least one light emitting diode is located at a first end of the light chamber. The diffusion plate is located at a second end of the light chamber. Moreover, plural light beams from the light emitting diode are transferred within the light chamber. After the light beams are reflected and scattered by an inner surface of the light chamber, the light beams are projected to the diffusion plate. After the light beams are transmitted through the diffusion plate, a surface light source is generated.

In an embodiment, the flat surface light source includes at least one light emitting diode and a light guide plate. After plural light beams from the at least one light emitting diode are introduced into the light guide plate, the plural light beams are guided by the light guide plate. After the plural light beams are transmitted through the light guide plate, a surface light source is generated.

In an embodiment, the flat surface light source further includes a polarizer. After the plural light beams are transmitted through the polarizer, the plural illumination beams in the first polarization state are generated.

In an embodiment, the imaging surface has a rectangular shape, and the side of the imaging surface is a short side of the imaging surface.

In an embodiment, the imaging element is a LCoS (liquid crystal on silicon) element.

In an embodiment, the polarization beam splitter is a reflective polarizer or a dual brightness enhancement film.

In an embodiment, the polarization beam splitter has a thin film structure

From the above descriptions, the present invention provides the display device. The distance between the geometric surface of the polarization beam splitter and the top glass cover of the imaging element has a specified distribution, and the flat surface light source has a specified inclination angle. Consequently, the imaging surface of the imaging element can be irradiated uniformly by the illumination beams from the flat surface light source within a specified viewing angle. Moreover, since the distance between the imaging element and the polarization beam splitter is shortened, the overall thickness and volume of the display device are reduced. It is not necessary to use the injection molding process or the grinding process of forming the precise optical element to produce the polarization beam splitter of the present invention. In addition, the display device is not equipped with additional precise optical elements. Consequently, the process of producing the components of the display device is simplified, and the display device is cost-effective. In other words, the display device is industrially valuable.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates an illumination system disclosed in U.S. Pat. No. 6,433,935;

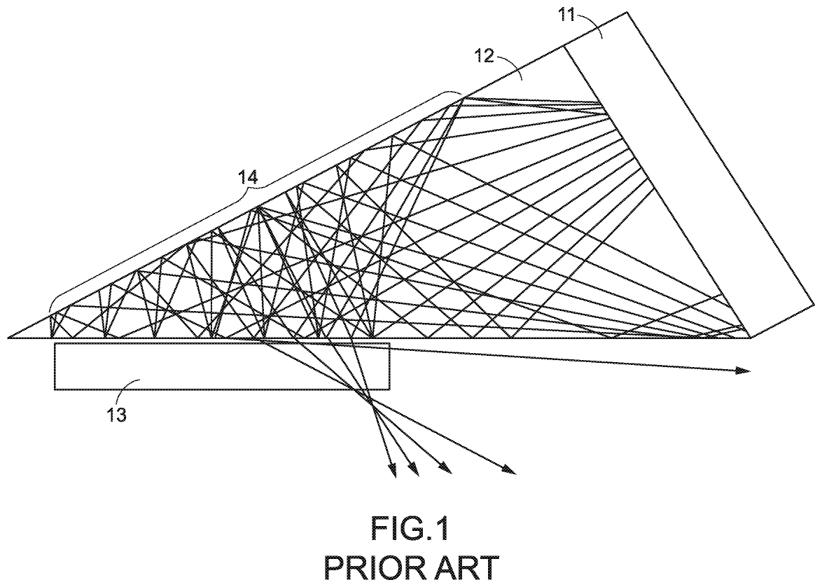

FIG. 2 schematically illustrates a polarization beam splitter (PBS) assembly disclosed in U.S. Pat. No. 6,976,759;

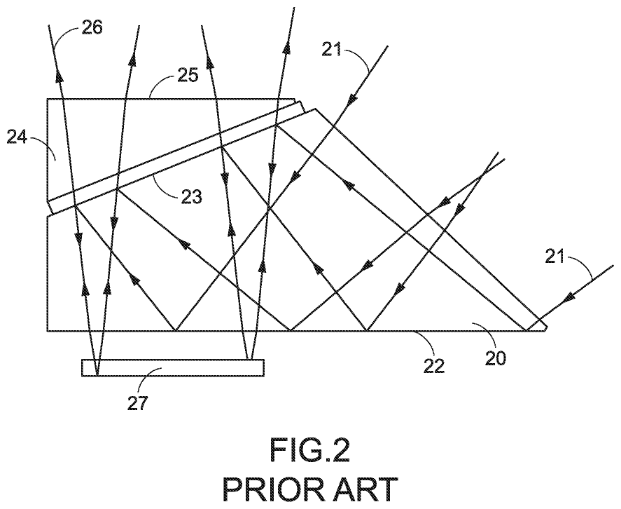

FIG. 3 schematically illustrates an image display system disclosed in U.S. Pat. No. 7,529,029;

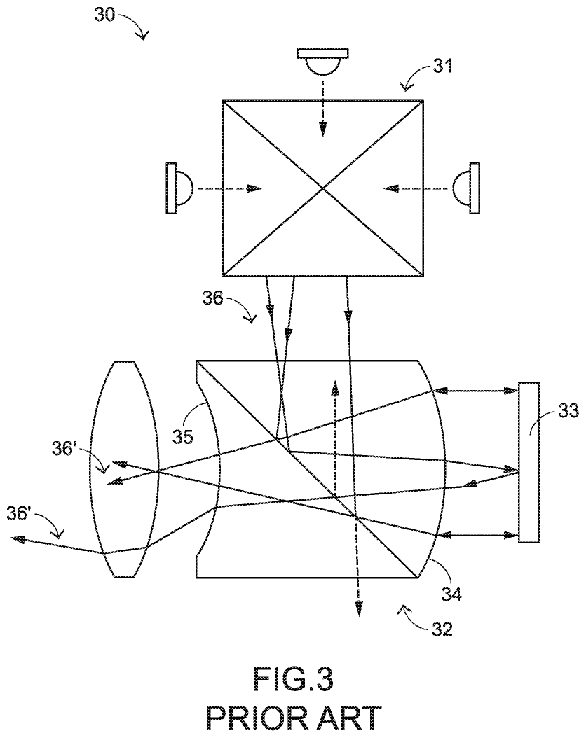

FIG. 4 is a schematic perspective view illustrating a display device according to an embodiment of the present invention;

FIG. 5 schematically illustrates an imaging element of the display device as shown in FIG. 4 and the viewing angles of plural pixels on an imaging surface of the imaging element;

FIG. 6 schematically illustrates the optical paths of the display device as shown in FIG. 4;

FIG. 7 schematically illustrates a first exemplary flat surface light source used in the display device as shown in FIG. 4;

FIG. 8 is a schematic perspective view illustrating a portion of the flat surface light source as shown in FIG. 7;

FIG. 9 schematically illustrates a second exemplary flat surface light source used in the display device as shown in FIG. 4;

FIG. 10 schematically illustrates a third exemplary flat surface light source used in the display device as shown in FIG. 4;

FIG. 11 schematically illustrates the geometric concepts of the display device as shown in FIG. 4 according to a coordinate system; and

FIG. 12 schematically illustrates plural positions of the imaging surface of the imaging element for calculating the illumination uniformity and the relationship between the plural positions and the edges of the imaging surface.

### DETAILED DESCRIPTION OF THE PREFERRED EMBODIMENT

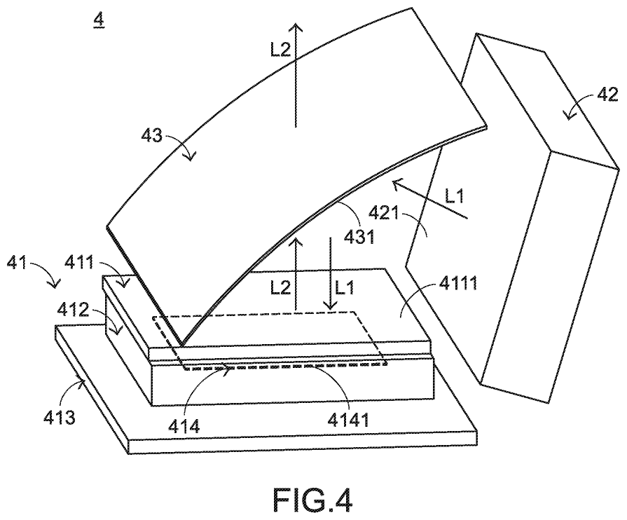

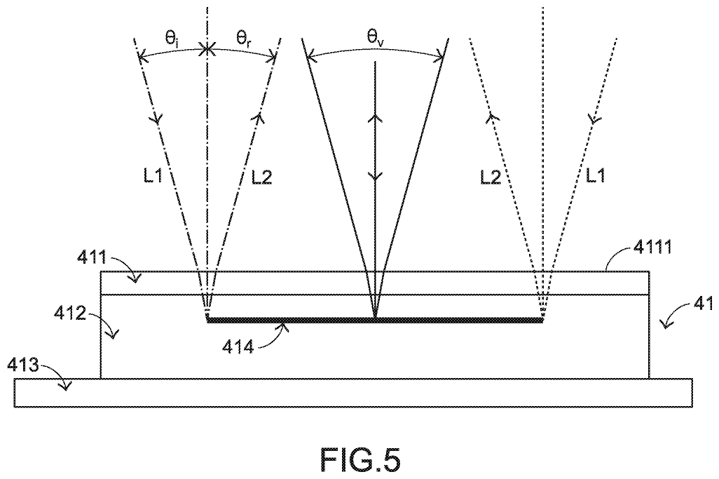

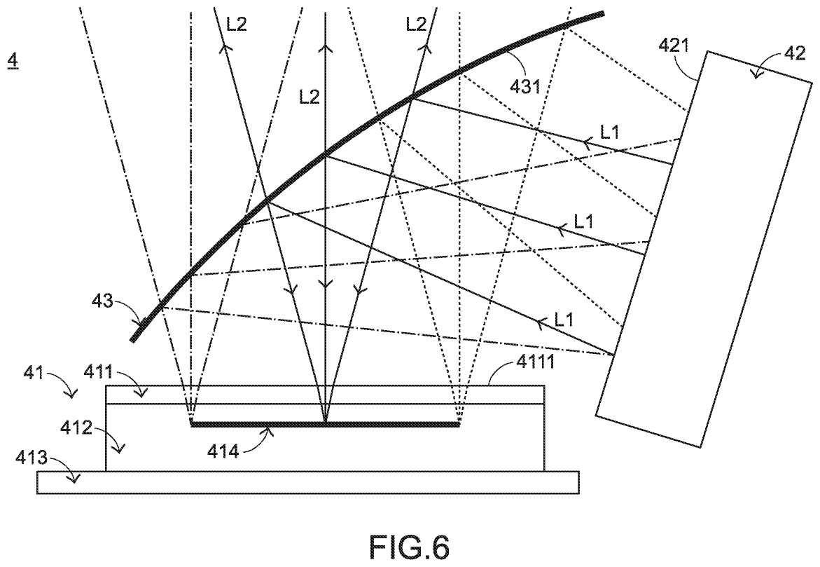

Please refer to FIGS. 4, 5 and 6. FIG. 4 is a schematic perspective view illustrating a display device according to an embodiment of the present invention. FIG. 5 schematically illustrates an imaging element of the display device as shown in FIG. 4 and the viewing angles of plural pixels on an imaging surface of the imaging element. FIG. 6 schematically illustrates the optical paths of the display device as shown in FIG. 4. The display device 4 comprises an imaging element 41, a flat surface light source 42 and a polarization beam splitter 43. The imaging element 41 has an imaging surface 414 for providing an image. The flat surface light source 42 has a light emitting surface 421 for providing plural illumination beams L1. Moreover, the normal line of the light emitting surface 421 of the flat surface light source 42 and the normal line of the imaging surface 414 of the imaging element 41 are not perpendicular to each other.

The polarization beam splitter 43 is arranged between the flat surface light source 42 and the imaging element 41. Moreover, the polarization beam splitter 43 has a geometric surface 431. When an illumination beam L1 in a first polarization state and from the flat surface light source 42 is projected on the geometric surface 431, the illumination beam L1 is reflected to the imaging element 41. When the illumination beam L1 in the first polarization state is projected on the imaging surface 414 of the imaging element 41, the illumination beam L1 is reflected as an imaging beam. After the imaging beam is exited from the imaging element 41, an imaging beam L2 in a second polarization state is generated. The imaging beam L2 in the second polarization state is directed to the polarization beam splitter 43. After the imaging beam L2 in the second polarization state is transmitted through the geometric surface 431 of the polarization beam splitter 43, the imaging beam L2 in the second polarization state is outputted.

Moreover, the illumination beam L1 in the first polarization state is projected on each pixel of the imaging surface 414 of the imaging element 41 at an incidence angle θᵢ. When the illumination beam L1 in the first polarization state is projected on the imaging surface 414 of the imaging element 41, the imaging beam L2 in the second polarization state is reflected at a reflection angle θᵣ. The reflection angle θᵣ is equal to the incidence angle θᵢ. Consequently, as shown in FIG. 5, the field of view θᵥ of each pixel is determined according to the incidence angle θᵢ of illumination beam L1 on the pixel.

In an embodiment, the imaging element 41 is a LCoS (liquid crystal on silicon) element. The imaging element 41 comprises a top glass cover 411, a circuit board 413 and an intermediate structure 412. The intermediate structure 412 is arranged between the top glass cover 411 and the circuit board 413. The intermediate structure 412 contains an electrode layer, a liquid crystal layer, an alignment layer, a reflective layer, a silicon crystal layer, and so on. The components of the intermediate structure 412 are well known to those skilled in the art, and are not redundantly described herein. The imaging surface 414 is disposed within the intermediate structure 412 and has a rectangular shape. In this embodiment, the polarization beam splitter 43 has a thin film structure. An example of the polarization beam splitter 43 includes but is not limited to a reflective polarizer or a dual brightness enhancement film (DBEF). The geometric surface 431 is a uniaxial curvy surface with a curvature.

Hereinafter, three examples of the flat surface light source 42 will be described.

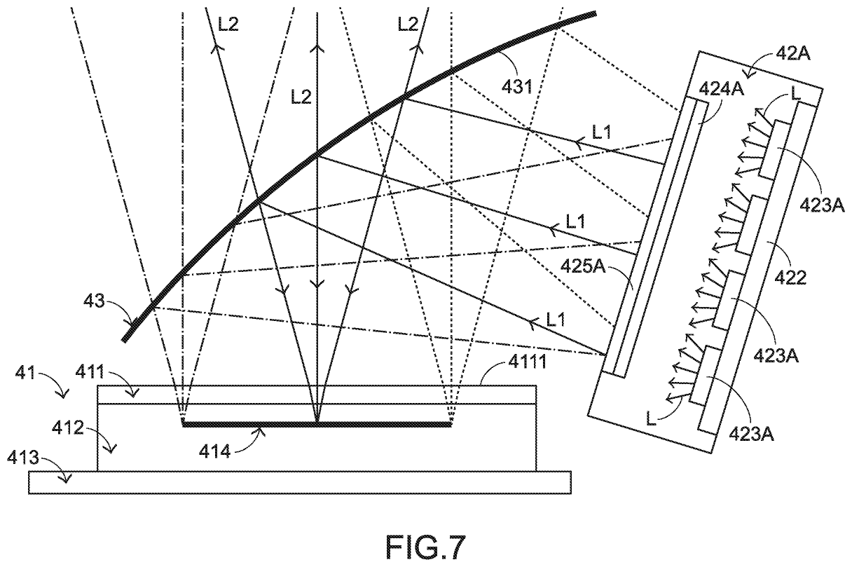

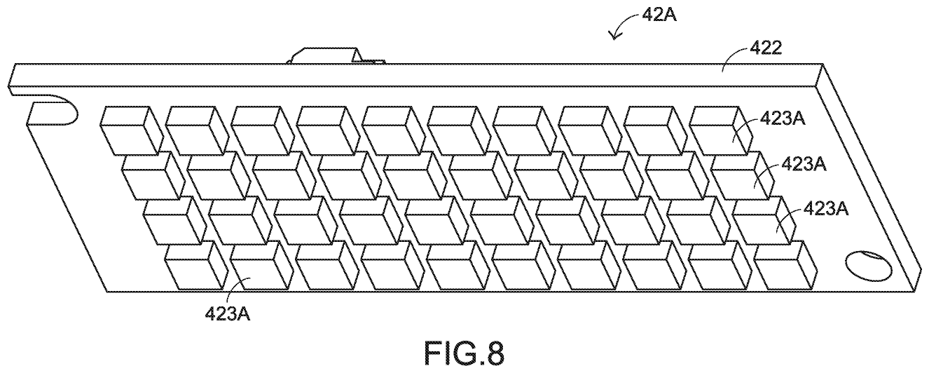

Please refer to FIGS. 7 and 8. FIG. 7 schematically illustrates a first exemplary flat surface light source used in the display device as shown in FIG. 4. FIG. 8 is a schematic perspective view illustrating a portion of the flat surface light source as shown in FIG. 7. In this embodiment, the flat surface light source 42A comprises a substrate 422, plural light emitting diodes 423A, a diffusion plate 424A and a polarizer 425A. The plural light emitting diodes 423A are arranged on the substrate 422 in a two-dimensional array. When the plural light beams L from the plural light emitting diodes 423A are projected to the diffusion plate 424A, the light beams L are scattered. After the light beams L are transmitted through the diffusion plate 424A, a uniform surface light source is generated. After the light beams L are transmitted through the polarizer 425A, the plural illumination beams L1 in the first polarization state are generated. Due to the arrangement of the polarizer 425A, portions of the light beams L passing through the diffusion plate 424A will not be directly transmitted through the polarization beam splitter 43. Consequently, the possibility of generating the stray light is reduced, and the contrast and displaying efficacy of the display device 4 are enhanced. However, the polarizer 425A is not the essential component of the flat surface light source 42A.

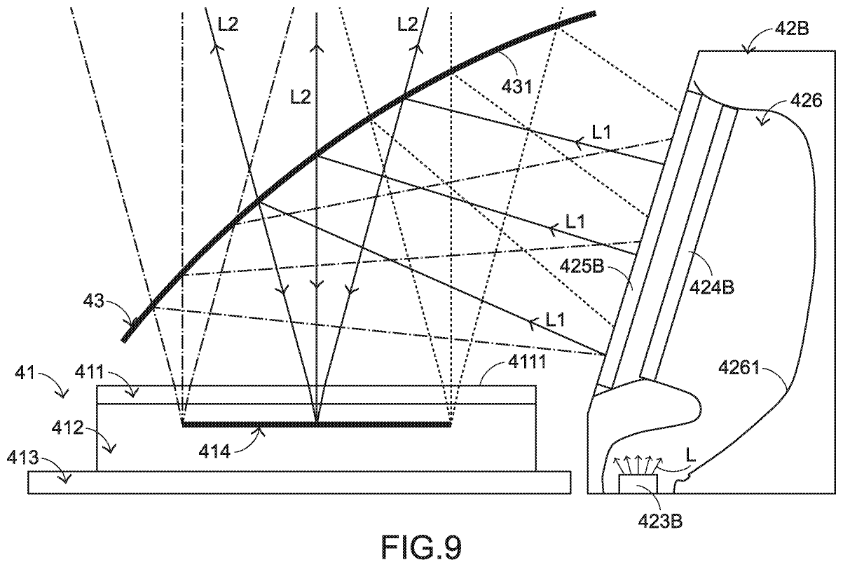

FIG. 9 schematically illustrates a second exemplary flat surface light source used in the display device as shown in FIG. 4. In this embodiment, the flat surface light source 42B comprises a light chamber 426, at least one light emitting diode 423B, a diffusion plate 424B and a polarizer 425B. The light emitting diode 423B is located at a first end of the light chamber 426. The diffusion plate 424B is located at a second end of the light chamber 426. The plural light beams L from the light emitting diode 423B are transferred within the light chamber 426. After the light beams L are reflected and scattered by an inner surface 4261 of the light chamber 426 many times, the light beams are projected to the diffusion plate 424B. The light beams L are also scattered within the diffusion plate 424B. After the light beams L are transmitted through the diffusion plate 424B, a uniform surface light source is generated. After the light beams L are transmitted through the polarizer 425B, the plural illumination beams L1 in the first polarization state are generated. Due to the arrangement of the polarizer 425B, portions of the light beams L passing through the diffusion plate 424B will not be directly transmitted through the polarization beam splitter 43. Consequently, the possibility of generating the stray light is reduced, and the contrast and displaying efficacy of the display device 4 are enhanced. However, the polarizer 425B is not the essential component of the flat surface light source 42B.

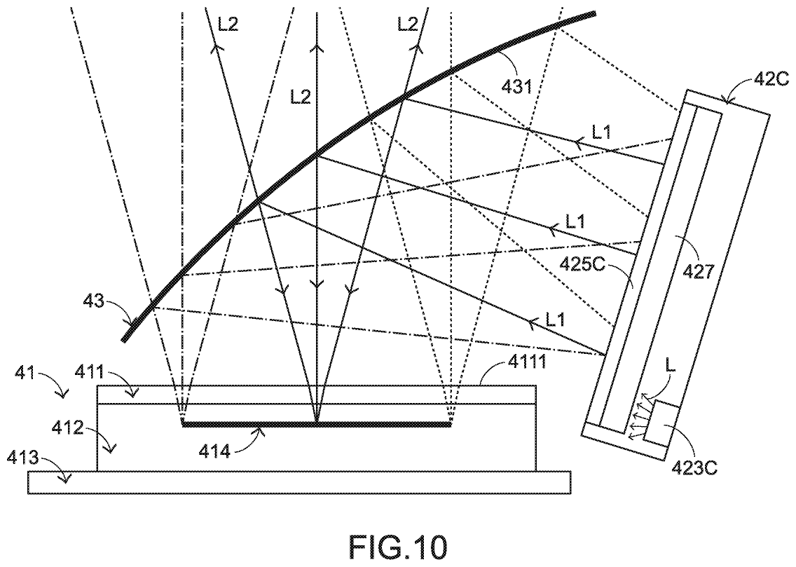

FIG. 10 schematically illustrates a third exemplary flat surface light source used in the display device as shown in FIG. 4. In this embodiment, the flat surface light source 42C comprises at least one light emitting diode 423C, a light guide plate 427 and a polarizer 425C. After plural light beams L from the at least one light emitting diode 423C are introduced into the light guide plate 427, the light beams L are guided by the light guide plate 427 and reflected and scattered within the light guide plate 427 many times. After the light beams L are transmitted through the light guide plate 427, a uniform surface light source is generated. After the light beams L are transmitted through the polarizer 425C, the plural illumination beams L1 in the first polarization state are generated. Due to the arrangement of the polarizer 425C, portions of the light beams L passing through the light guide plate 427 will not be directly transmitted through the polarization beam splitter 43. Consequently, the possibility of generating the stray light is reduced, and the contrast and displaying efficacy of the display device 4 are enhanced. However, the polarizer 425c is not the essential component of the flat surface light source 42C.

The above examples are presented herein for purpose of illustration and description only. The type of the imaging element, the shape of the imaging surface, the type of the polarization beam splitter, the shape of the geometric surface and the type of the flat surface light source are not restricted. It is noted that numerous modifications and alterations may be made while retaining the teachings of the invention.

Moreover, the distance between the geometric surface 431 of the polarization beam splitter 43 and the top glass cover 411 of the imaging element 41 has a specified distribution, and the flat surface light source 42 has a specified inclination angle. Consequently, the imaging surface 414 of the imaging element 41 can be irradiated uniformly by the illumination beams L1 from the flat surface light source 42 within a specified field of view θᵥ. In an embodiment, the display device further comprises a light-transmissible carrier (not shown). The light-transmissible carrier has an optical curvy surface corresponding to the geometric surface 431 of the polarization beam splitter 43. Consequently, the polarization beam splitter 43 is installed on the light-transmissible carrier. Preferably but not exclusively, the light-transmissible carrier is produced by a glass grinding process or a plastic molding process.

The distance distribution between the geometric surface 431 of the polarization beam splitter 43 and the top glass cover 411 of the imaging element 41 and the relationship between the distance distribution and the inclination angle of the flat surface light source 42 will be described as follows.

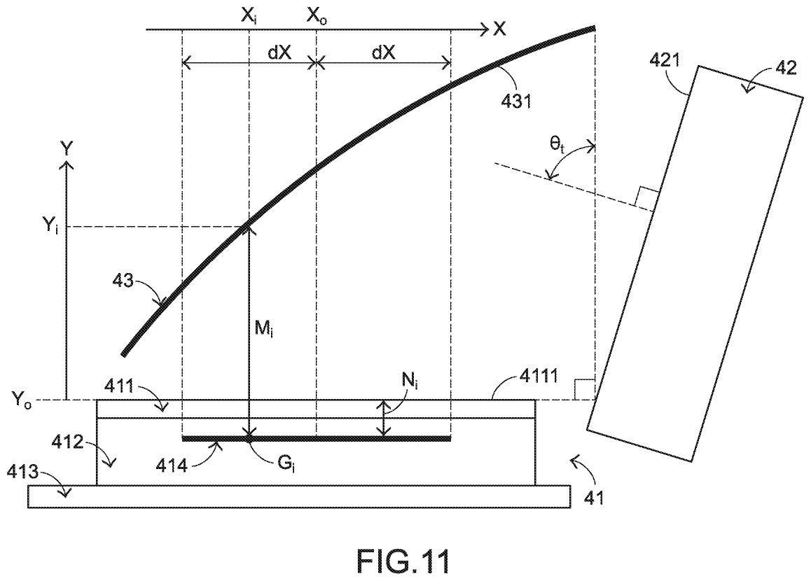

FIG. 11 schematically illustrates the geometric concepts of the display device as shown in FIG. 4 according to a coordinate system. In the coordinate system of FIG. 11, a first coordinate axis (e.g., the X axis) is parallel with a side of the imaging surface 414 of the imaging element 41 and perpendicular to the normal line of the imaging surface 414. In the embodiment as shown in FIG. 4, the side of the imaging surface 414 is a short side 4141 of the imaging surface 414. The origin X₀ of the first coordinate axis (e.g., the X axis) is located at a middle point of the short side 4141 of the imaging surface 414. The axial direction of the first coordinate axis (e.g., the X axis) faces the flat surface light source 42. In the coordinate system of FIG. 11, a second coordinate axis (e.g., the Y axis) is parallel with the normal line of the imaging surface 414. The origin Y₀ of the second coordinate axis (e.g., the Y axis) is located at the top surface of the imaging element 41 (i.e., a top surface 4111 of the top glass cover 411). The axis direction of the second coordinate axis (e.g., the Y axis) faces the polarization beam splitter 43.

Moreover, there is an included angle θₜ between the normal line of the light emitting surface 421 of the flat surface light source 42 and the normal line of the imaging surface 414 of the imaging element 41. According to the first coordinate axis (e.g., the X axis), a position Gᵢ on the imaging surface 414 of the imaging element 41 is defined as Xᵢ. The spacing distance between the position Gᵢ of the imaging surface 414 and the geometric surface 431 of the polarization beam splitter 43 along the normal line of the imaging surface 414 is defined as Mᵢ. The spacing distance between the position Gᵢ of the imaging surface 414 and the top surface of the imaging element 41 (i.e., a top surface 4111 of the top glass cover 411) along the normal line of the imaging surface 41 is defined as Nᵢ. Moreover, a half of the length of the short side 4141 of imaging surface 414 is defined as dX.

If a half of the length of the short side 4141 (dX) is smaller than 2.75 mm, the display device 4 satisfies the following mathematic formulae (1)˜(4):

−0.047385 Xᵢ²+0.771625 Xᵢ₊3.4≤Yᵢ; (1)

Yᵢ≤−0.047385 Xᵢ²+0.771625 Xᵢ+5; (2)

Yᵢ=Mᵢ−Nᵢ; and (3)

69°≤θₜ≤78°. (4)

If the half of the length of the short side 4141 (dX) is larger than 2.75 mm and smaller than 3.5 mm, the display device 4 further satisfies the following mathematic formulae (5)˜(8):

−0.043299 Xᵢ²+0.745345 Xᵢ+4≤Yᵢ; (5)

Yᵢ≤−0.043299 Xᵢ²+0.745345 Xᵢ+6; (6)

Yᵢ=Mᵢ−Nᵢ; and (7)

68.5°≤θₜ≤82.5°. (8)

As the position Gᵢ on the imaging surface 414 of the imaging element 41 is moved along the axis direction of the first coordinate axis (e.g., the X axis), the position Gᵢ is closer to the flat surface light source 42 and the Xᵢ is increased. That is, the spacing distance Mᵢ between the position Gᵢ of the imaging surface 414 and the geometric surface 431 of the polarization beam splitter 43 along the normal line of the imaging surface 414 is increased.

In case that the display device 4 of the present invention satisfies the above mathematic formulae, the imaging surface 414 of the imaging element 41 can be irradiated uniformly by the illumination beams L1 from the flat surface light source 42. In accordance with the present invention, the illumination uniformity on the imaging surface 414 of the imaging element 41 has a specific definition.

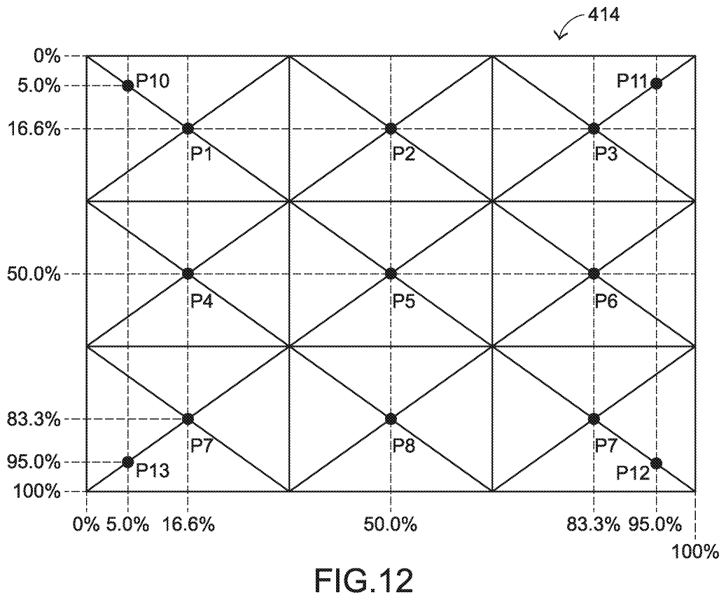

FIG. 12 schematically illustrates plural positions of the imaging surface of the imaging element for calculating the illumination uniformity and the relationship between the plural positions and the edges of the imaging surface. For example, the distance between the position P1 and the top edge of the imaging surface 414 is 16.6% of the length of the left side of the imaging surface 414, and the distance between the position P1 and left side of the imaging surface 414 is equal to 16.6% of the length of the top side of the imaging surface 414. The rest of the positions P2˜P13 may be deduced by analogy. When the positions P1˜P13 are irradiated by the illumination beams L1, the illumination values of the pixels on these positions within a specified field of view may be expressed as E1˜E13. The illumination uniformity U on the imaging surface 414 of the imaging element 41 may be expressed by the following formula:

U=(Eₘᵢₙ/Eₘₐₓ)×100%.

In the above mathematic formula, Eₘᵢₙ is the minimum of these illumination values E1˜E13, and Eₘₐₓ is the maximum of these illumination values E1˜E13.

The imaging surface 414 has a short side 4141. If a half of the length of the short side 4141 (dX) is smaller than 2.75 mm, the display device 4 further satisfies the following mathematic formulae (a1)˜(a6):

if Xᵢ=0, 3.6≤Yᵢ≤3.8 (see Example 10, Example 11 and Example 12 as follows); (a1)

if Xᵢ=0, 3.8≤Yᵢ≤4.0 (see Example 7, Example 8, Example 9 and Example 19 as follows); (a2)

if Xᵢ=0, 4.0≤Yᵢ≤4.2 (see Example 6, Example 17, Example 18, Example 20 and Example 21 as follows); (a3)

if Xᵢ=0, 4.2≤Yᵢ≤4.4 (see Example 5, Example 16, Example 23, Example 25, Example 26 and Example 27 as follows); (a4)

if Xᵢ=0, 4.4≤Yᵢ≤4.6 (see Example 3, Example 4, Example 13, Example 14, Example 22 and Example 24 as follows); and (a5)

if Xᵢ=0, 4.6≤Yᵢ≤4.8 (see Example 1, Example 2 and Example 15 as follows). (a6)

If the half of the length of the short side 4141 (dX) is larger than 2.75 mm and smaller than 3.5 mm, the display device 4 further satisfies the following mathematic formulae (b1)˜(b8):

if Xᵢ=0, 4.2≤Yᵢ≤4.4 (see Example 38 as follows); (b1)

if Xᵢ=0, 4.4≤Yᵢ≤4.6 (see Example 37, Example 39, Example 40, Example 41, Example 53 and Example 54 as follows); (b2)

if Xᵢ=0, 4.6≤Yᵢ≤4.8 (see Example 34, Example 36 and Example 52 as follows); (b3)

if Xᵢ=0, 4.8≤Yᵢ≤5.0 (see Example 31, Example 33, Example 35, Example 49, Example 51, Example 60, Example 61, Example 62 and Example 63 as follows); (b4)

if Xᵢ=0, 5.0≤Yᵢ≤5.2 (see Example 48, Example 50, Example 57, Example 58 and Example 59 as follows); (b5)

if Xᵢ=0, 5.2≤Yᵢ≤5.4 (see Example 30, Example 32, Example 43, Example 45, Example 46, Example 47, Example 55 and Example 56 as follows); (b6)

if Xᵢ=0, 5.4≤Yᵢ≤5.6 (see Example 29, Example 42 and Example 44 as follows); and (b7)

if Xᵢ=0, 5.6≤Yᵢ≤5.8 (see Example 28 as follows). (b8)

Hereinafter, sixty three examples obtained according to the above mathematic formula (1)˜(4) or the above mathematic formula (5)˜(8) are listed in the following tables (e.g., Table 1˜63). In all of these embodiments, the illumination uniformity U on the imaging surface 414 of the imaging element 41 is larger than 85%.

TABLE 1
Example 1
dX = 2.376 mm, θᵥ = 20°, θₜ = 76.523°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.713 | 3.444 | 4.136 | 4.792 | 5.415 | 6.005 | 6.565 |

TABLE 2
Example 2
dX = 2.376 mm, θᵥ = 20°, θₜ = 75.457°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.657 | 3.391 | 4.080 | 4.726 | 5.333 | 5.903 | 6.438 |

TABLE 3
Example 3
dX = 2.376 mm, θᵥ = 20°, θₜ = 76.522°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.406 | 3.164 | 3.871 | 4.530 | 5.146 | 5.722 | 6.261 |

TABLE 4
Example 4
dX = 2.376 mm, θᵥ = 20°, θₜ = 72.455°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.590 | 3.311 | 3.977 | 4.592 | 5.161 | 5.687 | 6.173 |

TABLE 5
Example 5
dX = 2.376 mm, θᵥ = 20°, θₜ = 73.528°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.335 | 3.078 | 3.760 | 4.388 | 4.966 | 5.499 | 5.989 |

TABLE 6
Example 6
dX = 2.376 mm, θᵥ = 20°, θₜ = 75.632°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.991 | 2.768 | 3.479 | 4.132 | 4.731 | 5.281 | 5.787 |

TABLE 7
Example 7
dX = 2.376 mm, θᵥ = 20°, θₜ = 76.963°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.713 | 2.517 | 3.250 | 3.918 | 4.529 | 5.089 | 5.601 |

TABLE 8
Example 8
dX = 2.376 mm, θᵥ = 20°, θₜ = 75.568°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.671 | 2.472 | 3.195 | 3.848 | 4.440 | 4.977 | 5.463 |

TABLE 9
Example 9
dX = 2.376 mm, θᵥ = 20°, θₜ = 72.072°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.795 | 2.571 | 3.262 | 3.877 | 4.427 | 4.919 | 5.356 |

TABLE 10
Example 10
dX = 2.376 mm, θᵥ = 20°, θₜ = 73.248°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.533 | 2.335 | 3.044 | 3.674 | 4.233 | 4.730 | 5.171 |

TABLE 11
Example 11
dX = 2.376 mm, θᵥ = 20°, θₜ = 72.05°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.494 | 2.294 | 2.995 | 3.611 | 4.154 | 4.632 | 5.051 |

TABLE 12
Example 12
dX = 2.376 mm, θᵥ = 20°, θₜ = 69.62°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.561 | 2.426 | 3.138 | 3.731 | 4.226 | 4.637 | 4.972 |

TABLE 13
Example 13
dX = 2.376 mm, θᵥ = 30°, θₜ = 77.166°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.351 | 3.166 | 3.907 | 4.586 | 5.206 | 5.775 | 6.296 |

TABLE 14
Example 14
dX = 2.376 mm, θᵥ = 30°, θₜ = 76.335°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.286 | 3.102 | 3.838 | 4.508 | 5.116 | 5.670 | 6.175 |

TABLE 15
Example 15
dX = 2.376 mm, θᵥ = 30°, θₜ = 72.565°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.496 | 3.277 | 3.975 | 4.603 | 5.168 | 5.676 | 6.132 |

TABLE 16
Example 16
dX = 2.376 mm, θᵥ = 30°, θₜ = 74.781°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.137 | 2.955 | 3.684 | 4.337 | 4.923 | 5.450 | 5.922 |

TABLE 17
Example 17
dX = 2.376 mm, θᵥ = 30°, θₜ = 75.563°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.914 | 2.751 | 3.495 | 4.157 | 4.749 | 5.278 | 5.751 |

TABLE 18
Example 18
dX = 2.376 mm, θᵥ = 30°, θₜ = 72.973°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.000 | 2.817 | 3.535 | 4.169 | 4.731 | 5.227 | 5.665 |

TABLE 19
Example 19
dX = 2.376 mm, θᵥ = 30°, θₜ = 74.332°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.728 | 2.573 | 3.312 | 3.961 | 4.534 | 5.038 | 5.482 |

TABLE 20
Example 20
dX = 2.376 mm, θᵥ = 30°, θₜ = 72.912°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.771 | 2.659 | 3.407 | 4.044 | 4.588 | 5.052 | 5.445 |

TABLE 21
Example 21
dX = 2.376 mm, θᵥ = 30°, θₜ = 71.674°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.833 | 2.799 | 3.568 | 4.193 | 4.703 | 5.118 | 5.449 |

TABLE 22
Example 22
dX = 2.376 mm, θᵥ = 38°, θₜ = 75.678°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.307 | 3.159 | 3.915 | 4.589 | 5.191 | 5.730 | 6.211 |

TABLE 23
Example 23
dX = 2.376 mm, θᵥ = 38°, θₜ = 76.774°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.058 | 2.935 | 3.709 | 4.395 | 5.006 | 5.551 | 6.036 |

TABLE 24
Example 24
dX = 2.376 mm, θᵥ = 38°, θₜ = 72.834°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.306 | 3.142 | 3.873 | 4.515 | 5.082 | 5.581 | 6.021 |

TABLE 25
Example 25
dX = 2.376 mm, θᵥ = 38°, θₜ = 72.889°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 2.155 | 3.002 | 3.738 | 4.381 | 4.946 | 5.441 | 5.874 |

TABLE 26
Example 26
dX = 2.376 mm, θᵥ = 38°, θₜ = 73.436°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.957 | 2.821 | 3.568 | 4.218 | 4.785 | 5.281 | 5.711 |

TABLE 27
Example 27
dX = 2.376 mm, θᵥ = 38°, θₜ = 72.664°

| | | | | | | | |
|---|---|---|---|---|---|---|---|
| Xᵢ (mm) | −2.376 | −1.584 | −0.792 | 0 | 0.792 | 1.584 | 2.376 |
| Yᵢ (mm) | 1.944 | 2.840 | 3.595 | 4.239 | 4.789 | 5.260 | 5.660 |

TABLE 28
Example 28
dX = 3.096 mm, θᵥ = 20°, θₜ = 75.41°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 3.035 | 3.980 | 4.861 | 5.685 | 6.455 | 7.175 | 7.848 |

TABLE 29
Example 29
dX = 3.096 mm, θᵥ = 20°, θₜ = 76.553°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.767 | 3.732 | 4.632 | 5.472 | 6.258 | 6.992 | 7.679 |

TABLE 30
Example 30
dX = 3.096 mm, θᵥ = 20°, θₜ = 77.947°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.441 | 3.432 | 4.355 | 5.216 | 6.021 | 6.773 | 7.476 |

TABLE 31
Example 31
dX = 3.096 mm, θᵥ = 20°, θₜ = 79.352°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.113 | 3.131 | 4.078 | 4.961 | 5.785 | 6.555 | 7.275 |

TABLE 32
Example 32
dX = 3.096 mm, θᵥ = 20°, θₜ = 73.604°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.589 | 3.538 | 4.409 | 5.210 | 5.946 | 6.625 | 7.249 |

TABLE 33
Example 33
dX = 3.096 mm, θᵥ = 20°, θₜ = 74.657°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.315 | 3.291 | 4.182 | 4.999 | 5.748 | 6.435 | 7.064 |

TABLE 34
Example 34
dX = 3.096 mm, θᵥ = 20°, θₜ = 75.71°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.040 | 3.044 | 3.958 | 4.791 | 5.551 | 6.246 | 6.880 |

TABLE 35
Example 35
dX = 3.096 mm, θᵥ = 20°, θₜ = 71.782°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.287 | 3.250 | 4.115 | 4.894 | 5.596 | 6.228 | 6.796 |

TABLE 36
Example 36
dX = 3.096 mm, θᵥ = 20°, θ0ₜ = 71.607°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.139 | 3.113 | 3.982 | 4.759 | 5.456 | 6.078 | 6.634 |

TABLE 37
Example 37
dX = 3.096 mm, θᵥ = 20°, θₜ = 72.355°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.897 | 2.896 | 3.782 | 4.570 | 5.273 | 5.899 | 6.454 |

TABLE 38
Example 38
dX = 3.096 mm, θᵥ = 20°, θₜ = 73.381°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.627 | 2.655 | 3.563 | 4.366 | 5.079 | 5.711 | 6.270 |

TABLE 39
Example 39
dX = 3.096 mm, θᵥ = 20°, θₜ = 73.012°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.562 | 2.668 | 3.605 | 4.405 | 5.092 | 5.679 | 6.179 |

TABLE 40
Example 40
dX = 3.096 mm, θᵥ = 20°, θₜ = 71.435°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.571 | 2.696 | 3.627 | 4.406 | 5.061 | 5.608 | 6.061 |

TABLE 41
Example 41
dX = 3.096 mm, θᵥ = 20°, θₜ = 70.667°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.576 | 2.714 | 3.643 | 4.412 | 5.050 | 5.576 | 6.004 |

TABLE 42
Example 42
dX = 3.096 mm, θᵥ = 30°, θₜ = 78.871°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.562 | 3.618 | 4.584 | 5.472 | 6.289 | 7.041 | 7.734 |

TABLE 43
Example 43
dX = 3.096 mm, θᵥ = 30°, θₜ = 78.358°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.484 | 3.543 | 4.506 | 5.388 | 6.194 | 6.933 | 7.611 |

TABLE 44
Example 44
dX = 3.096 mm, θᵥ = 30°, θₜ = 76.531°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.565 | 3.605 | 4.546 | 5.400 | 6.178 | 6.885 | 7.530 |

TABLE 45
Example 45
dX = 3.096 mm, θᵥ = 30°, θₜ = 77.424°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.311 | 3.377 | 4.337 | 5.206 | 5.993 | 6.707 | 7.355 |

TABLE 46
Example 46
dX = 3.096 mm, θᵥ = 30°, θₜ = 74.727°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.487 | 3.521 | 4.445 | 5.275 | 6.021 | 6.692 | 7.295 |

TABLE 47
Example 47
dX = 3.096 mm, θᵥ = 30°, θₜ = 72.502°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.594 | 3.605 | 4.502 | 5.301 | 6.014 | 6.649 | 7.215 |

TABLE 48
Example 48
dX = 3.096 mm, θᵥ = 30°, θₜ = 73.361

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.345 | 3.381 | 4.296 | 5.107 | 5.829 | 6.469 | 7.037 |

TABLE 49
Example 49
dX = 3.096 mm, θᵥ = 30°, θₜ = 74.234°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.094 | 3.156 | 4.090 | 4.914 | 5.644 | 6.290 | 6.861 |

TABLE 50
Example 50
dX = 3.096 mm, θᵥ = 30°, θₜ = 68.904°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.528 | 3.520 | 4.382 | 5.133 | 5.789 | 6.361 | 6.855 |

TABLE 51
Example 51
dX = 3.096 mm, θᵥ = 30°, θₜ = 70.186°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.233 | 3.258 | 4.143 | 4.913 | 5.582 | 6.163 | 6.664 |

TABLE 52
Example 52
dX = 3.096 mm, θᵥ = 30°, θₜ = 71.485°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.938 | 2.996 | 3.906 | 4.693 | 5.375 | 5.966 | 6.474 |

TABLE 53
Example 53
dX = 3.096 mm, θᵥ = 30°, θₜ = 71.953°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.745 | 2.834 | 3.761 | 4.555 | 5.237 | 5.823 | 6.322 |

TABLE 54
Example 54
dX = 3.096 mm, θᵥ = 30°, θₜ = 71.291°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.754 | 2.851 | 3.776 | 4.561 | 5.230 | 5.799 | 6.278 |

TABLE 55
Example 55
dX = 3.096 mm, θᵥ = 38°, θₜ = 82.045°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.963 | 3.192 | 4.272 | 5.229 | 6.081 | 6.843 | 7.523 |

TABLE 56
Example 56
dX = 3.096 mm, θᵥ = 38°, θₜ = 81.164°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.966 | 3.195 | 4.269 | 5.212 | 6.047 | 6.787 | 7.444 |

TABLE 57
Example 57
dX = 3.096 mm, θᵥ = 38°, θₜ = 80.236°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.962 | 3.188 | 4.252 | 5.181 | 5.998 | 6.718 | 7.354 |

TABLE 58
Example 58
dX = 3.096 mm, θᵥ = 38°, θₜ = 79.321°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.968 | 3.200 | 4.258 | 5.173 | 5.971 | 6.669 | 7.278 |

TABLE 59
Example 59
dX = 3.096 mm, θᵥ = 38°, θₜ = 76.863°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.025 | 3.170 | 4.168 | 5.043 | 5.815 | 6.495 | 7.095 |

TABLE 60
Example 60
dX = 3.096 mm, θᵥ = 38°, θₜ = 75.87°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.009 | 3.147 | 4.134 | 4.994 | 5.749 | 6.410 | 6.989 |

TABLE 61
Example 61
dX = 3.096 mm, θᵥ = 38°, θₜ = 75.06°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.964 | 3.101 | 4.080 | 4.929 | 5.669 | 6.315 | 6.876 |

TABLE 62
Example 62
dX = 3.096 mm, θᵥ = 38°, θₜ = 73.886°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 2.005 | 3.160 | 4.136 | 4.970 | 5.686 | 6.301 | 6.826 |

TABLE 63
Example 63
dX = 3.096 mm, θᵥ = 38°, θₜ = 73.33°

| | | | | | | | |
|---|---|---|---|---|---|---|---|
| Xᵢ (mm) | −3.096 | −2.064 | −1.032 | 0 | 1.032 | 2.064 | 3.096 |
| Yᵢ (mm) | 1.984 | 3.177 | 4.164 | 4.992 | 5.690 | 6.278 | 6.770 |

From the above descriptions, the present invention provides the display device. The distance between the geometric surface of the polarization beam splitter and the top glass cover of the imaging element has a specified distribution, and the flat surface light source has a specified inclination angle. Consequently, the imaging surface of the imaging element can be irradiated uniformly by the illumination beams from the flat surface light source within a specified viewing angle. Moreover, since the distance between the imaging element and the polarization beam splitter is shortened, the overall thickness and volume of the display device are reduced. It is not necessary to use the injection molding process or the grinding process of forming the precise optical element to produce the polarization beam splitter of the present invention. In addition, the display device is not equipped with additional precise optical elements. Consequently, the process of producing the components of the display device is simplified, and the display device is cost-effective. In other words, the display device is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A display device, comprising:
an imaging element having an imaging surface for providing an image;
a flat surface light source having a light emitting surface for providing plural illumination beams, wherein a normal line of the light emitting surface and a normal line of the imaging surface are not perpendicular to each other; and
a polarization beam splitter arranged between the flat surface light source and the imaging element, and having a geometric surface, wherein when at least portions of plural illumination beams in a first polarization state and from the flat surface light source are projected on the geometric surface, the portions of the plural illumination beams in the first polarization state are reflected to the imaging element, wherein after the portions of the plural illumination beams in the first polarization state are projected on the imaging element and exited from the imaging element, the portions of the plural illumination beams in the first polarization state are converted into imaging beams in a second polarization state, wherein at least portions of the imaging beams in the second polarization state are transmitted through the geometric surface, so that the image is outputted.

2. The display device according to claim 1, wherein if a half of a length of a side of the imaging surface is smaller than 2.75 mm, the display device satisfies following mathematic formulae:
−0.047385 Xᵢ²+0.771625 Xᵢ+3.4≤Yᵢ;
Yᵢ≤−0.047385 Xᵢ²+0.771625 Xᵢ+5;
Yᵢ=Mᵢ−Nᵢ; and
69°≤θₜ≤78°,
wherein Xᵢ is a position of the imaging surface and defined according to a coordinate axis, the coordinate axis is parallel with the side of the imaging surface and perpendicular to the normal line of the imaging surface, Mᵢ is a spacing distance between the position of the imaging surface and the geometric surface along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

3. The display device according to claim 2, wherein the display device further satisfies following mathematic formulae (a1)˜(a6):
if Xᵢ=0, 3.6≤Yᵢ≤3.8; (a1)
if Xᵢ=0, 3.8≤Yᵢ≤4.0; (a2)
if Xᵢ=0, 4.0≤Yᵢ≤4.2; (a3)
if Xᵢ=0, 4.2≤Yᵢ≤4.4; (a4)
if Xᵢ=0, 4.4≤Yᵢ≤4.6; and (a5)
if Xᵢ=0, 4.6≤Yᵢ≤4.8. (a6)

4. The display device according to claim 2, wherein the imaging surface has a rectangular shape, and the side of the imaging surface is a short side of the imaging surface.

5. The display device according to claim 1, wherein if a half of a length of a side of the imaging surface is larger than 2.75 mm and smaller than 3.5 mm, the display device satisfies following mathematic formulae:
−0.043299 Xᵢ²+0.745345 Xᵢ+4≤Yᵢ;
Yᵢ≤−0.043299 Xᵢ²+0.745345 Xᵢ+6;
Yᵢ=Mᵢ−Nᵢ; and
68.5°≤θₜ≤82.5°.
wherein Xᵢ is a position of the imaging surface and defined according to a coordinate axis, the coordinate axis is parallel with the side of the imaging surface and perpendicular to the normal line of the imaging surface, Mᵢ is a spacing distance between the position of the imaging surface and the geometric surface along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

6. The display device according to claim 5, wherein the display device further satisfies following mathematic formulae (b1)˜(b8):
if Xᵢ=0, 4.2≤Yᵢ≤4.4; (b1)
if Xᵢ=0, 4.4≤Yᵢ≤4.6; (b2)
if Xᵢ=0, 4.6≤Yᵢ≤4.8; (b3)
if Xᵢ=0, 4.8≤Yᵢ≤5.0; (b4)
if Xᵢ=0, 5.0≤Yᵢ≤5.2; (b5)
if Xᵢ=0, 5.2≤Yᵢ≤5.4; (b6)
if Xᵢ=0, 5.4≤Yᵢ≤5.6; and (b7)
if Xᵢ=0, 5.6≤Yᵢ≤5.8. (b8)

7. The display device according to claim 5, wherein the imaging surface has a rectangular shape, and the side of the imaging surface is a short side of the imaging surface.

8. The display device according to claim 1, wherein the imaging element comprises a top glass cover, an intermediate structure and a circuit board, wherein the intermediate structure is arranged between the top glass cover and the circuit board, the imaging surface is disposed within the intermediate structure, and a top surface of the imaging element is a top surface of the top glass cover.

9. The display device according to claim 1, wherein a position of the imaging surface is defined according to a coordinate axis, and the coordinate axis is parallel with the side of the imaging surface and perpendicular to the normal line of the imaging surface, wherein as the position of the imaging surface is moved along an axial direction of the coordinate axis, a spacing distance between the position of the imaging surface and the geometric surface along the normal line of the imaging surface is increased.

10. The display device according to claim 9, wherein the imaging surface has a rectangular shape, and the side of the imaging surface is a short side of the imaging surface.

11. The display device according to claim 1, wherein the flat surface light source comprises a substrate, plural light emitting diodes and a diffusion plate, wherein the plural light emitting diodes are disposed on the substrate to provide light beams, wherein after the light beams are transmitted through the diffusion plate, a surface light source is generated.

12. The display device according to claim 1, wherein the flat surface light source comprises a light chamber, at least one light emitting diode and a diffusion plate, wherein the at least one light emitting diode is located at a first end of the light chamber, the diffusion plate is located at a second end of the light chamber, and plural light beams from the light emitting diode are transferred within the light chamber, wherein after the light beams are reflected and scattered by an inner surface of the light chamber, the light beams are projected to the diffusion plate, wherein after the light beams are transmitted through the diffusion plate, a surface light source is generated.

13. The display device according to claim 1, wherein the flat surface light source comprises at least one light emitting diode and a light guide plate, wherein after plural light beams from the at least one light emitting diode are introduced into the light guide plate, the plural light beams are guided by the light guide plate, wherein after the plural light beams are transmitted through the light guide plate, a surface light source is generated.

14. The display device according to claim 1, wherein the flat surface light source further comprises a polarizer, wherein after plural light beams are transmitted through the polarizer, the plural illumination beams in the first polarization state are generated.

15. The display device according to claim 1, wherein the imaging element is a LCoS (liquid crystal on silicon) element; and/or
the polarization beam splitter is a reflective polarizer or a dual brightness enhancement film.

16. The display device according to claim 1, wherein the polarization beam splitter has a thin film structure.

17. A display device, comprising:
an imaging element having an imaging surface for providing an image;
a flat surface light source providing plural illumination beams; and
a polarization beam splitter arranged between the flat surface light source and the imaging element, wherein when at least portions of plural illumination beams in a first polarization state and from the flat surface light source are projected on the polarization beam splitter, the portions of the plural illumination beams in the first polarization state are reflected to the imaging element, wherein at least portions of imaging beams in the second polarization state and from the imaging element are transmitted through the polarization beam splitter, so that the image is outputted,
wherein a position of the imaging surface is defined according to a coordinate axis, and the coordinate axis is parallel with a side of the imaging surface and perpendicular to a normal line of the imaging surface, wherein as the position of the imaging surface is moved along an axial direction of the coordinate axis, a spacing distance between the position of the imaging surface and the geometric surface along the normal line of the imaging surface is increased.

18. The display device according to claim 17, wherein the flat surface light source has a light emitting surface, wherein a normal line of the light emitting surface and the normal line of the imaging surface are not perpendicular to each other.

19. The display device according to claim 18, wherein if a half of a length of the side of the imaging surface is smaller than 2.75 mm, the display device satisfies following mathematic formulae:
−0.047385 Xᵢ²+0.771625 Xᵢ+3.4≤Yᵢ;
Yᵢ≤−0.047385 Xᵢ²+0.771625 Xᵢ+5;
Yᵢ=Mᵢ−Nᵢ; and
69°≤θₜ≤78°,
wherein Xᵢ is the position of the imaging surface and defined according to the coordinate axis, Mᵢ is the spacing distance between the position of the imaging surface and the polarization beam splitter along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

20. The display device according to claim 19, wherein the display device satisfies following mathematic formulae (a1)˜(a6):
if Xᵢ=0, 3.6≤Yᵢ≤3.8; (a1)
if Xᵢ=0, 3.8≤Yᵢ≤4.0; (a2)
if Xᵢ=0, 4.0≤Yᵢ≤4.2; (a3)
if Xᵢ=0, 4.2≤Yᵢ≤4.4; (a4)
if Xᵢ=0, 4.4≤Yᵢ≤4.6; and (a5)
if Xᵢ=0, 4.6≤Yᵢ≤4.8. (a6)

21. The display device according to claim 18, wherein if a half of a length of the side of the imaging surface is larger than 2.75 mm and smaller than 3.5 mm, the display device satisfies following mathematic formulae:
−0.043299 Xᵢ²+0.745345 Xᵢ+4≤Yᵢ;
Yᵢ≤−0.043299 Xᵢ²+0.745345 Xᵢ+6;
Yᵢ=Mᵢ−Nᵢ; and
68.5°≤θₜ≤82.5°.
wherein Xᵢ is the position of the imaging surface and defined according to the coordinate axis, Mᵢ is the spacing distance between the position of the imaging surface and the polarization beam splitter along the normal line of the imaging surface, Nᵢ is a spacing distance between the position of the imaging surface and a top surface of the imaging element along the normal line of the imaging surface, and θₜ is an included angle between the normal line of the imaging surface and the normal line of the light emitting surface.

22. The display device according to claim 21, wherein the display device further satisfies following mathematic formulae (b1)˜(b8):
if Xᵢ=0, 4.2≤Yᵢ≤4.4; (b1)
if Xᵢ=0, 4.4≤Yᵢ≤4.6; (b2)
if Xᵢ=0, 4.6≤Yᵢ≤4.8; (b3)
if Xᵢ=0, 4.8≤Yᵢ≤5.0; (b4)
if Xᵢ=0, 5.0≤Yᵢ≤5.2; (b5)
if Xᵢ=0, 5.2≤Yᵢ≤5.4; (b6)
if Xᵢ=0, 5.4≤Yᵢ≤5.6; and (b7)
if Xᵢ=0, 5.6≤Yᵢ≤5.8. (b8)

23. The display device according to claim 17, wherein the imaging element comprises a top glass cover, an intermediate structure and a circuit board, wherein the intermediate structure is arranged between the top glass cover and the circuit board, the imaging surface is disposed within the intermediate structure, and a top surface of the imaging element is a top surface of the top glass cover.

24. The display device according to claim 17, wherein the flat surface light source comprises a substrate, plural light emitting diodes and a diffusion plate, wherein the plural light emitting diodes are disposed on the substrate to provide light beams, wherein after the light beams are transmitted through the diffusion plate, a surface light source is generated.

25. The display device according to claim 17, wherein the flat surface light source comprises a light chamber, at least one light emitting diode and a diffusion plate, wherein the at least one light emitting diode is located at a first end of the light chamber, the diffusion plate is located at a second end of the light chamber, and plural light beams from the light emitting diode are transferred within the light chamber, wherein after the light beams are reflected and scattered by an inner surface of the light chamber, the light beams are projected to the diffusion plate, wherein after the light beams are transmitted through the diffusion plate, a surface light source is generated.

26. The display device according to claim 17, wherein the flat surface light source comprises at least one light emitting diode and a light guide plate, wherein after plural light beams from the at least one light emitting diode are introduced into the light guide plate, the plural light beams are guided by the light guide plate, wherein after the plural light beams are transmitted through the light guide plate, a surface light source is generated.

27. The display device according to claim 17, wherein the flat surface light source further comprises a polarizer, wherein after plural light beams are transmitted through the polarizer, the plural illumination beams in the first polarization state are generated.

28. The display device according to claim 17, wherein the imaging surface has a rectangular shape, and the side of the imaging surface is a short side of the imaging surface.

29. The display device according to claim 17, wherein the imaging element is a LCoS (liquid crystal on silicon) element; and/or
the polarization beam splitter is a reflective polarizer or a dual brightness enhancement film.

30. The display device according to claim 17, wherein the polarization beam splitter has a thin film structure.
